(19) United States
(12) Patent Application Publication
(10) Pub. No.: US 2026/0260611 A1
(43) Pub. Date: Sep. 3, 2026

(54) DISPLAY PANEL AND DISPLAY DEVICE

(71) Applicant: Xiamen Tianma Display Technology Co., Ltd., Xiamen (CN)

(72) Inventors: Jian KUANG, Xiamen (CN); Lei WANG, Xiamen (CN); Yana GAO, Xiamen (CN); Xingyao ZHOU, Xiamen (CN)

(21) Appl. No.: 19/261,300

(22) Filed: Jul. 7, 2025

(30) Foreign Application Priority Data
Feb. 28, 2025 (CN) 202510238327.0

(51) Int. Cl. G09G 3/3233

(52) U.S. Cl. CPC G09G 3/3233; G09G 2300/043; G09G 2300/0819; G09G 2310/0286; G09G 2320/0252; G09G 2320/0271

(57) ABSTRACT

A display panel and a display device are provided. The pixel circuit of the display panel includes a driving unit, a light-emitting control unit and a first control unit, a control terminal of the light-emitting control unit is connected to a first control line, and a control terminal of the first control unit is connected to a second control line. An output terminal of the first shift register is electrically connected to the first control line, and an output terminal of the second shift register is electrically connected to the second control line. The first potential signal line is electrically connected to the first shift register, the second potential signal line is electrically connected to the second shift register, and the first potential signal line and the second potential signal line are isolated from each other.

### CROSS-REFERENCE TO RELATED APPLICATION

This application claims the priority of Chinese Patent Application No. 202510238327.0, filed on Feb. 28, 2025, the content of which is incorporated by reference in its entirety.

### TECHNICAL FIELD

The present disclosure generally relates to the field of display technologies and, more particularly, relates to a display panel and a display device.

### BACKGROUND

Organic light-emitting diode (OLED) is a current-type organic light-emitting device, which refers to a device that emits light through carrier injection and recombination of organic semiconductor materials and luminescent materials under the drive of an electric field. OLED has become one of the most researched areas in the field of display because of its excellent color saturation, contrast and response speed, and because its material is thinner, transparent, flexible, and can achieve a variety of designs.

However, the organic light-emitting display panels are prone to regular light and dark horizontal stripes when displaying low grayscale, which greatly affects the display quality. The present disclosed display panels and display devices are direct to solve such a problem and other problems in the arts.

### SUMMARY

One aspect of the present disclosure provides a display panel. The display panel includes a pixel circuit; a light-emitting element electrically connected with the pixel circuit; a first shift register; a second shift register; a first potential signal line; and a second potential signal line. The pixel circuit includes a driving unit, a light-emitting control unit and a first control unit, a control terminal of the light-emitting control unit is connected to a first control line, and a control terminal of the first control unit is connected to a second control line. An output terminal of the first shift register is electrically connected to the first control line, and an output terminal of the second shift register is electrically connected to the second control line. The first potential signal line is electrically connected to the first shift register, the second potential signal line is electrically connected to the second shift register, and the first potential signal line and the second potential signal line are isolated from each other. The first potential signal line and the second potential signal line are both connected to high-level signals or both connected to low-level signals.

Another aspect of the present disclosure includes a display device. The display device includes a display panel. The display panel includes a pixel circuit; a light-emitting element electrically connected with the pixel circuit; a first shift register; a second shift register; a first potential signal line; and a second potential signal line. The pixel circuit includes a driving unit, a light-emitting control unit and a first control unit, a control terminal of the light-emitting control unit is connected to a first control line, and a control terminal of the first control unit is connected to a second control line. An output terminal of the first shift register is electrically connected to the first control line, and an output terminal of the second shift register is electrically connected to the second control line. The first potential signal line is electrically connected to the first shift register, the second potential signal line is electrically connected to the second shift register, and the first potential signal line and the second potential signal line are isolated from each other. The first potential signal line and the second potential signal line are both connected to high-level signals or both connected to low-level signals.

Other aspects of the present disclosure can be understood by those skilled in the art in light of the description, the claims, and the drawings of the present disclosure.

### BRIEF DESCRIPTION OF THE DRAWINGS

To illustrate the technical solutions in the embodiments of the present disclosure more clearly, the following briefly introduces the accompanying drawings used in the description of the embodiments. Obviously, the accompanying drawings in the following description are only some embodiments of the present disclosure, for those of ordinary skill in the art, other drawings can also be obtained from these drawings without creative effort.

FIG. 1 illustrates a top view of a display panel;

FIG. 2 illustrates a schematic connection diagram between the pixel circuit and the light-emitting element of the display panel in FIG. 1;

FIG. 3 illustrates a sequence diagram of signal corresponding to FIG. 2;

FIG. 4 illustrates a sequence diagram of EM signal corresponding to FIG. 2;

FIG. 5 illustrates another sequence diagram of EM signal corresponding to FIG. 2;

FIG. 6 illustrates a circuit diagram of the shift register of the display panel in FIG. 1;

FIG. 7 illustrates a schematic when the display panel in FIG. 1 shows lateral stripes;

FIG. 8 illustrates an exemplary display panel according to various embodiments of the present disclosure;

FIG. 9 illustrates another exemplary display panel according to various embodiments of the present disclosure;

FIG. 10 illustrates another exemplary display panel according to various embodiments of the present disclosure;

FIG. 11 illustrates another exemplary display panel according to various embodiments of the present disclosure;

FIG. 12 illustrates another exemplary display panel according to various embodiments of the present disclosure;

FIG. 13 illustrates another exemplary display panel according to various embodiments of the present disclosure;

FIG. 14 illustrates another exemplary display panel according to various embodiments of the present disclosure;

FIG. 15 illustrates another exemplary display panel according to various embodiments of the present disclosure;

FIG. 16 illustrates another exemplary display panel according to various embodiments of the present disclosure;

FIG. 17 illustrates another exemplary display panel according to various embodiments of the present disclosure; and

FIG. 18 illustrates an exemplary display device according to various embodiments of the present disclosure.

### DETAILED DESCRIPTION

To more clearly understand the above-mentioned purposes, features and advantages of the present disclosure, the scheme of the present disclosure will be further described below. It should be noted that the embodiments of the present disclosure and the features in the embodiments may be combined with each other without conflict.

In the following description, many specific details are explained to facilitate a full understanding of the present disclosure, but the present disclosure may also be implemented in other ways different from those described herein. Obviously, the embodiments in the specification are only part of the embodiments of the present disclosure, not all of them.

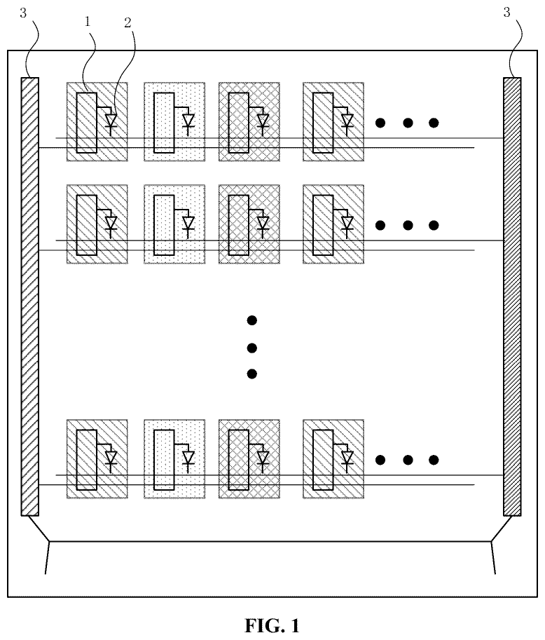

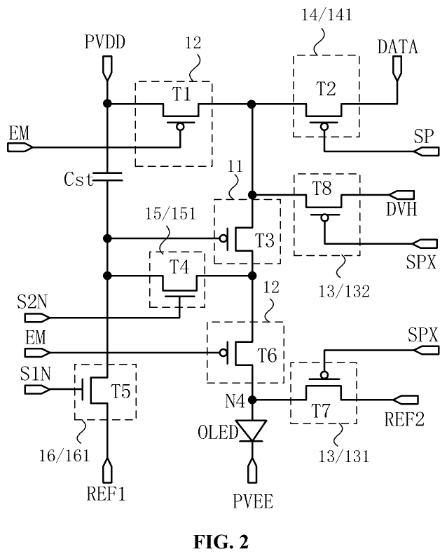

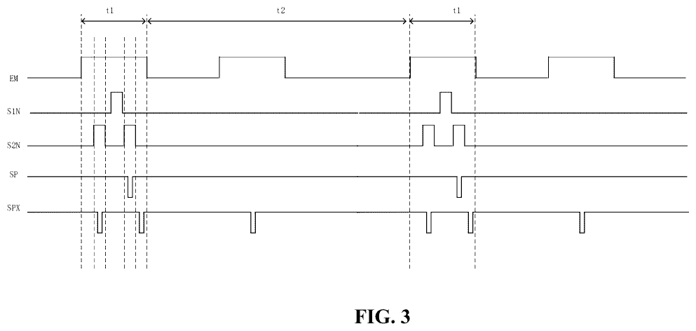

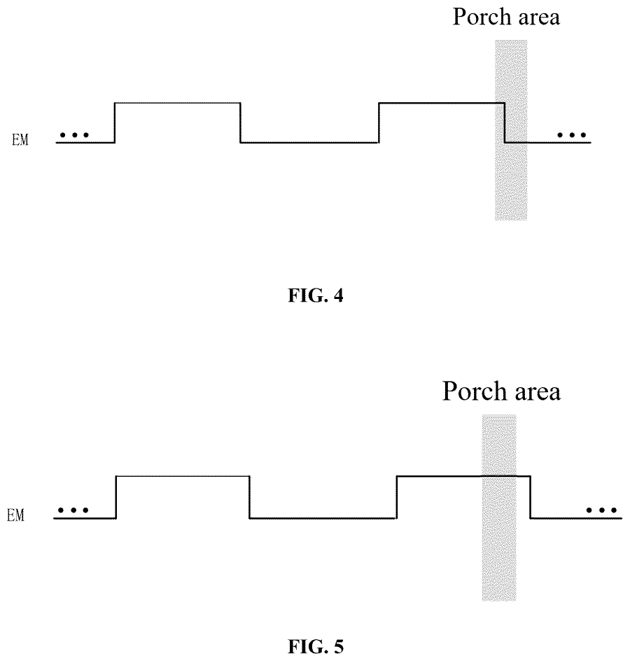

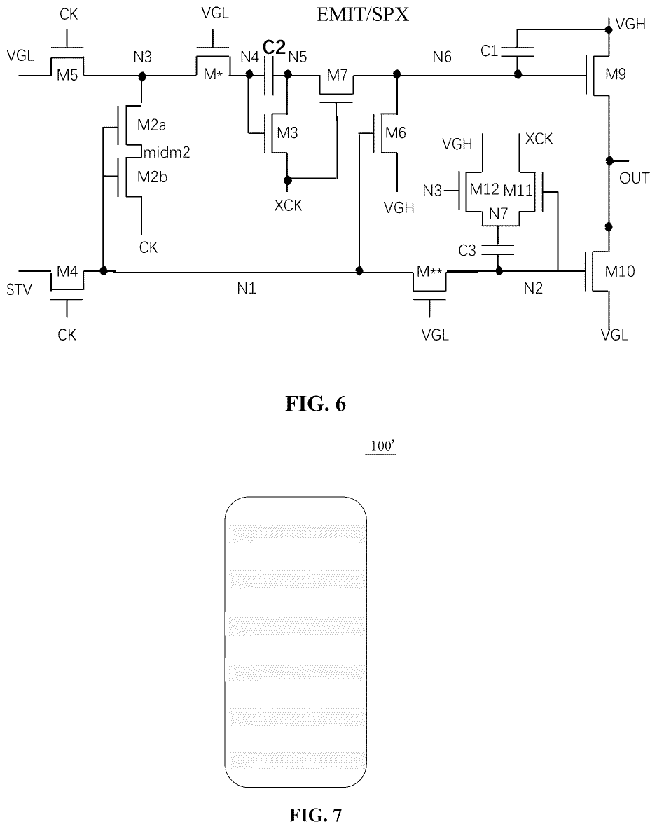

FIG. 1 illustrates a top view of a display panel, FIG. 2 is a schematic diagram of an electrical connection structure between a pixel circuit and a light-emitting element in the display panel provided in FIG. 1, FIG. 3 is a signal sequence diagram corresponding to FIG. 2, FIG. 4 is sequence diagram of an EM signal corresponding to FIG. 2, FIG. 5 is another sequence diagram of an EM signal corresponding to FIG. 2, FIG. 6 is a circuit diagram of a shift register unit in the display panel provided in FIG. 1, and FIG. 7 is a schematic diagram of a horizontal stripe phenomenon occurring in the display panel described in FIG. 1. As shown in FIG. 1-FIG. 7, a display panel generally includes a pixel circuit 1 and a light-emitting element 2 electrically connected to each other. The pixel circuit 1 may be an 8T1C pixel circuit, that is, the pixel circuit 1 includes 8 transistors (transistor T1, transistor T2, transistor T3, transistor T4, transistor T5, transistor T6, transistor T7, and transistor T8) and one capacitor (capacitor Cst). The transistor T4 and the transistor T5 electrically connected to the gate of transistor T3 are both N-type transistors, and the remaining transistors are P-type transistors. That is, transistors T4 and T5 are turned on when the gate potential is high, and the remaining transistors are turned on when their gate potentials of are low. The N4 node potential in the pixel circuit provided in FIG. 2 is the anode potential of the OLED light-emitting element, and the potential difference between the anode potential and the cathode potential of the OLED light-emitting element determines the magnitude of the current flowing through the OLED light-emitting element. The transistor T7 in the pixel circuit provided in FIG. 2 is used to reset the N4 node potential. It should be noted that the present disclosure does not elaborate on the connection structure and working principle of the above-mentioned pixel circuit, and the specific explanation of the pixel circuit in the relevant technology may be referred to for understanding.

In the display panel, the gate control signal of the transistor T1 and the transistor T6 is an EM signal, the gate control signal of the transistor T2 is an SP signal, the gate control signal of the transistor T4 is an S2N signal, the gate control signal of the transistor T5 is an S1N signal, and the gate control signal of the transistor T7 and the transistor T8 is an SPX signal. The switching levels of the EM signal, the SP signal, the S1N signal, the S2N signal, and the SPX signal are high-level/low-level. The high-level signal is an effective signal for controlling the conduction of the transistor T4 and the transistor T5, and the low-level signal is an effective signal for controlling the conduction of other transistors except the transistor T4 and the transistor T5. The SPX signal, the EM signal, the SP signal, the S1N signal, the S2N signal, and the SPX signal are usually generated and provided by a gate drive circuit (gate on array, GOA), and the gate drive circuit includes a plurality of shift registers 3, and the SPX signal, the EM signal, the SP signal, the S1N signal, the S2N signal, and the SPX signal are usually generated and provided by different shift registers 3. The shift register 3 generally includes cascaded shift register units, and the output signal of each shift register unit is used as both a control signal for the corresponding transistor in each row of pixel circuit 1 and an input signal for the next level of bit register unit. The signal input of the first level is generated by the driver chip configuration. Accordingly, to drive each level of shift register unit to output a drive signal, the driver chip needs to input a potential signal to the shift register 3, and the potential signal includes a high-level signal and a low-level signal. Exemplarily, referring to FIG. 6, the driver chip provides a potential signal (VGL signal, VGH signal), a clock signal (CK signal, XCK signal) and a start signal (STV signal) to the shift register unit, so that the output terminal of the shift register unit outputs a corresponding control signal to the transistor in the pixel circuit connected thereto, thereby realizing the control of the state of the transistor in the pixel circuit. The potential signal line connected to the shift register 3 for outputting the EM signal and the potential signal line connected to the shift register 3 for outputting the SPX signal are usually connected and set.

It should be noted that the circuit of the shift register unit for outputting the EM signal and the shift register unit for outputting the SPX signal shown in FIG. 6 can adopt the circuit structure of the shift register unit of FIG. 6. The present disclosure does not elaborate on the connection structure and working principle of the above-mentioned shift register unit. The details may be referred to the explanation of the shift register unit in the relevant technology. There may be differences in the circuits of the two, but both need to use potential signals, clock signals and start signals to generate and transmit signals. The display panel also includes a shift register 3 for outputting an SP signal, a shift register 3 for outputting an S1N signal, and a shift register 3 for outputting an S2N signal. Similarly, the driver chip provides a potential signal (VGL signal, VGH signal), a clock signal (CK signal and/or XCK signal) and a start signal (STV signal) to the shift register unit in this part of the shift register 3, so that the output terminal of the shift register unit outputs a corresponding control signal to the transistor in the pixel circuit connected thereto, thereby realizing the control of the state of the transistor in the pixel circuit. The present disclosure does not elaborate on the specific circuit structure and working principle of the shift register unit in this part of the shift register 3. The details may be referred to the explanation of the shift register unit in the relevant technology for understanding.

The display panel generally includes a display area (active area) and a porch area (this area is used to prepare for some voltage conversion, and can also be understood as a display blanking area. In display technology, it refers to the area on the display screen used for synchronization signal transmission, rather than the area used to display images. Generally, the active area is followed by the porch area. The porch area is a specific time period when the display device displays an image. During this period, no valid image information is displayed, but it is used for the transmission and processing of synchronization signals to ensure the correct synchronization and stable operation of the display device). The porch area is fixed, and the EM signal is a driving signal with multiple pulses. Therefore, during the display period, different areas of the display panel will have corresponding EM signals falling in the porch area, which will cause light and dark horizontal stripes.

As shown in FIG. 4, the EM signal has a falling edge in the porch region. At this time, there is no actual jump load, which will cause the jump load of the low-level signal used to drive the falling edge of the EM signal to decrease, and the voltage value of the low-level signal used to drive the EM signal is relatively lower than the set value, so that the difference between the low-level signal and the high-level signal used to drive the EM signal becomes relatively larger. Because the potential signal line connected to the shift register 3 for outputting the EM signal and the potential signal line connected to the shift register 3 for outputting the SPX signal are usually connected and arranged, that is, the low-level signal used to drive the EM signal and the low-level signal used to drive the SPX signal are common signals. When the difference between the low-level signal and the high-level signal used to drive the EM signal becomes relatively larger, the jump-up coupling amount the SPX signal becomes more, the potential of the N4 node is higher, and the brightness is brighter.

As shown in FIG. 5, the falling edge of the EM signal is not in the porch area. At this time, for the display area (active area) of the display panel, the low-level signal used to drive the falling edge of the EM signal has an additional jump-down load, and the voltage value of the low-level signal used to drive the EM signal is relatively higher than the set value, so that the difference between the low-level signal and the high-level signal used to drive the EM signal is relatively small. Because the potential signal line connected to the shift register 3 for outputting the EM signal and the potential signal line connected to the shift register 3 for outputting the SPX signal are usually connected and set, that is, the low-level signal used to drive the EM signal and the low-level signal used to drive the SPX signal are common signals. When the difference between the low-level signal and the high-level signal used to drive the EM signal is relatively small, the SPX signal jump-up coupling amount is reduced, the N4 node potential is low, and the brightness is dim. The final display screen shows that the display panel 100′ shown in FIG. 7 is prone to regular bright and dark horizontal stripes.

As can be seen from the above, when the display panel displays low grayscale, the state of the falling edge of the EM signal entering and exiting the porch area is different at different times, and the low-level signal used to drive the falling edge of the EM signal has a potential fluctuation in units of the EM signal cycle. Because the low-level signal used to drive the EM signal and the low-level signal used to drive the SPX signal are common signals, the SPX signal coupling amount also fluctuates periodically, resulting in the appearance of bright and dark horizontal stripes under the low grayscale screen.

Similarly, when the display panel displays low grayscale, the state of the falling edge of the EM signal entering and exiting the porch area is different at different times, and the high-level signal used to drive the falling edge of the EM signal has a potential fluctuation in units of the EM signal cycle. Because the high-level signal used to drive the EM signal and the high-level signal used to drive the SPX signal are common signals, the SPX signal coupling amount also fluctuates periodically, resulting in the appearance of bright and dark horizontal stripes under the low grayscale screen.

Based on the above problems, the present application provides a display panel and a display device. The display panel and the display device may solve the display problem of horizontal stripes and improve the display quality. The specific embodiments of the display panel and display device proposed in this application are described in detail as follows.

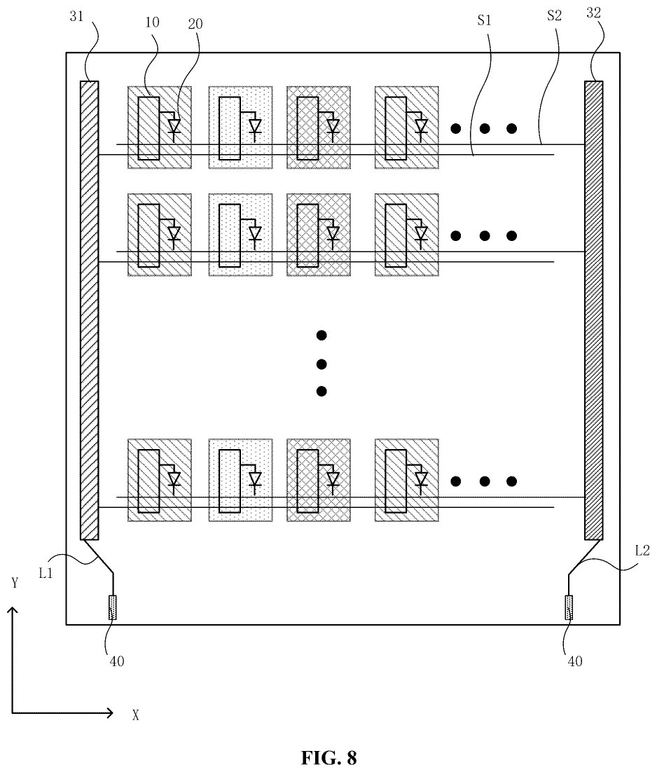

FIG. 8 is a planar schematic diagram of an exemplary display panel provided by one embodiment of the present disclosure. The structure of the pixel circuit in the display panel provided by the embodiment of the present disclosure may refer to FIG. 2. As shown in FIG. 2 and FIG. 8, the embodiment of the present disclosure provides a display panel, and the display panel may include an pixel circuit 10 and a light-emitting element 20 electrically connected to each other. The pixel circuit 10 may include a driving unit 11, a light-emitting control unit 12 and a first control unit 13. The control terminal of the light-emitting control unit 12 may be connected to the first control line S1, and the control terminal of the first control unit 13 may be connected to the second control line S2.

The display panel may include a first shift register 31 and a second shift register 32. The output terminal of the first shift register 31 may be electrically connected to the first control line S1, and the output terminal of the second shift register 32 may be electrically connected to the second control line S2.

The display panel may also include a first potential signal line L1 and a second potential signal line L2. The first potential signal line L1 may be electrically connected to the first shift register 31. The second potential signal line L2 may be electrically connected to the second shift register 32. The first potential signal line L1 and the second potential signal line L2 may be isolated from each other. The first potential signal line L1 and the second potential signal line L2 may be both connected to high-level signals or low-level signals.

The display panel provided in this embodiment may be an OLED display panel, and the display panel may include a pixel circuit 10 and a light-emitting element 20 electrically connected with each other. The pixel circuit 10 may be configured to provide current to the light-emitting element 20 to realize the light-emission of the light-emitting element 20.

The pixel circuit 10 may include a driving unit 11, a light-emitting control unit 12 and a first control unit 13. The control terminal of the light-emitting control unit 12 may be connected to the first control line S1. The display panel may include a first shift register 31. The output terminal of the first shift register 31 may be electrically connected to the first control line S1. The display panel may also include a first potential signal line L1. The first potential signal line L1 may be electrically connected to the first shift register 31. The first potential signal line L1 may be connected to the potential signal, so that the potential signal may be transmitted to the first shift register 31 via the first potential signal line L1. The first shift register 31 may generate a first control signal (EM signal) based on the signal including the potential signal, and transmit the first control signal (EM signal) to the control terminal of the light-emitting control unit 12 via the first control line S1, thereby realizing the control of the state of the light-emitting control unit 12.

The control terminal of the first control unit 13 may be connected to the second control line S2. The display panel may include a second shift register 32. The output terminal of the second shift register 32 may be electrically connected to the second control line S2. The display panel may also include a second potential signal line L2. The second potential signal line L2 may be electrically connected to the second shift register 32. The second potential signal line L2 may also be connected to the potential signal, so that the potential signal may be transmitted to the second shift register 32 via the second potential signal line L2. The second shift register 32 may generate a second control signal (SPX signal) based on the signal including the potential signal, and transmit the second control signal (SPX signal) to the control terminal of the first control unit 13 via the second control line S2, so that the state of the first control unit 13 may be controlled.

When the display panel is displayed at the low grayscale, the falling edge and/or rising edge of the first control signal (EM signal) at different times may enter and exit the porch area differently, and the potential signal used to drive the first control signal (EM signal) may have a potential fluctuation in units of the first control signal (EM signal) cycle.

In one embodiment, the first potential signal line L1 and the second potential signal line L2 may be isolated from each other, that is, the first potential signal line L1 and the second potential signal line L2 may be disconnected. Accordingly, the potential signal transmitted on the first potential signal line L1 may not affect the potential signal transmitted on the second potential signal line L2, so that when the potential signal used to drive the first control signal (EM signal) has a potential fluctuation in units of the first control signal (EM signal) period, the potential signal used to drive the second control signal (SPX signal) may not be coupled, so that the second control signal (SPX signal) may not have periodic coupling fluctuations, effectively reducing the display problem of bright and dark horizontal stripes of the display panel under the low grayscale display, which may be conducive to improving display quality.

Both the first potential signal line L1 and the second potential signal line L2 may be connected to high-level signal signals, that is, the first potential signal line L1 may be configured to connect to a high-level potential signal, and at the same time, the second potential signal line L2 may be configured to connect to a high-level potential signal. At this time, the first potential signal line L1 and the second potential signal line L2 may be disconnected, that is, the high-level potential signal transmitted on the first potential signal line L1 may not affect the high-level potential signal transmitted on the second potential signal line L2. Accordingly, when the high-level potential signal used to drive the first control signal (EM signal) has a potential fluctuation in units of the first control signal (EM signal) period, the high-level potential signal used to drive the second control signal (SPX signal) may not be coupled, so that the second control signal (SPX signal) may not have periodic coupling fluctuations, which may effectively reduce the display problem of bright and dark horizontal stripes of the display panel under low grayscale display, which may be conducive to improving display quality.

Similarly, both the first potential signal line L1 and the second potential signal line L2 may be connected to low-level signals, that is, the first potential signal line L1 may be used to connect to low-level potential signals, and at the same time, the second potential signal line L2 may be used to connect to low-level potential signals. At this time, the first potential signal line L1 and the second potential signal line L2 may be disconnected, that is, the low-level potential signal transmitted on the first potential signal line L1 may not affect the low-level potential signal transmitted on the second potential signal line L2. Accordingly, when the low-level potential signal used to drive the first control signal (EM signal) has a potential fluctuation in units of the first control signal (EM signal) period, the low-level potential signal used to drive the second control signal (SPX signal) may not be coupled, so that the second control signal (SPX signal) may not have periodic coupling fluctuations, which may effectively reduce the display problem of bright and dark horizontal stripes of the display panel under low grayscale display, which may be conducive to improving display quality.

Further, refer to FIG. 2 and FIG. 8, in another embodiment, the first control unit 13 may include a first reset unit 131. The control terminal of the first reset unit 131 may be connected to the second control line S2, the first terminal of the first reset unit 131 may be connected to the REF2 signal, and the second terminal of the first reset unit 131 may be connected to the N4 node. The potential of the N4 node in the pixel circuit 10 may be the anode potential of the light-emitting element 20. The first reset unit 131 in the pixel circuit 10 may be used to reset the potential of the N4 node. The first potential signal line L1 and the second potential signal line L2 may be disconnected, that is, the potential signal transmitted on the first potential signal line L1 may not affect the potential signal transmitted on the second potential signal line L2. Accordingly, when the potential signal used to drive the first control signal (EM signal) has a potential fluctuation in units of the first control signal (EM signal) period, the potential signal used to drive the second control signal (SPX signal) may not be coupled, so that the second control signal (SPX signal) may not have periodic coupling fluctuations, and may not affect the potential of the N4 node, effectively reducing the display problem of bright and dark horizontal stripes of the display panel under low grayscale display, which may be conducive to improving display quality.

Further, referring to FIG. 2 and FIG. 8, in some embodiments, the first control unit 13 may include a bias adjustment unit 132. The bias adjustment unit 132 may be electrically connected to the driving unit 11, and the bias adjustment unit 132 may be configured to implement the bias adjustment of the driving unit 11.

Specifically, the first control unit 13 may include a bias adjustment unit 132, the control terminal of the bias adjustment unit 132 may be connected to the second control line S2, the first terminal of the bias adjustment unit 132 may be connected to the DVH signal, and the second terminal of the bias adjustment unit 132 may be electrically connected to the driving unit 11. The bias adjustment unit 132 may be configured to implement the bias adjustment of the driving unit 11.

The control terminal of the first reset unit 131 may multiplex the second control signal (SPX signal) transmitted to the control terminal of the bias adjustment unit 132, that is, the control terminal of the bias adjustment unit 132 and the control terminal of the first reset unit 131 may both be connected to the second control line S2, which may be conducive to reducing circuit complexity and wiring difficulty.

The time sequence of the pixel circuit provided in the embodiment of the present disclosure may be referred to FIG. 3. Referring to FIG. 2, FIG. 3 and FIG. 8, in some embodiments, in the low-frequency working mode of the display panel, a holding period t2 may be inserted between two writing periods t1, and the control signal (SPX signal) transmitted by the second control line S2 may include at least one pulse in the holding period t2.

Specifically, the first control unit 13 may include a bias adjustment unit 132. The control terminal of the bias adjustment unit 132 may be connected to the second control line S2, the first terminal of the bias adjustment unit 132 may be connected to the DVH signal, and the second terminal of the bias adjustment unit 132 may be electrically connected to the driving unit 11. The bias adjustment unit 132 may be used to implement the bias adjustment of the driving unit 11. In the low-frequency working mode of the display panel, a holding period t2 may be inserted between the two writing periods t1, and the control signal (SPX signal) transmitted by the second control line S2 may include at least one pulse in the holding period t2, so that in the holding period t2, the bias adjustment unit 132 may bias the driving unit 11, which may effectively reduce the afterimage effect caused by long-term static images in the low-frequency working mode of the display panel.

Further, referring to FIG. 2 and FIG. 8, in some embodiments, the first potential signal line L1 and the second potential signal line L2 may be both connected to low-level signals. Specifically, when the second control signal (SPX signal) is a low-level signal, the first control unit 13 may be turned on. In this case, the fluctuation of the low-level potential signal used to drive the second control signal (SPX signal) may have a greater impact on the display problem of bright and dark horizontal stripes of the display panel under low grayscale display.

Both the first potential signal line L1 and the second potential signal line L2 may be connected to low-level signals, that is, the first potential signal line L1 may be a signal line for connecting to a low-level potential signal, and at the same time, the second potential signal line L2 may also be a signal line for connecting to a low-level potential signal. At this time, the first potential signal line L1 and the second potential signal line L2 may be disconnected, that is, the low-level potential signal transmitted on the first potential signal line L1 may not affect the low-level potential signal transmitted on the second potential signal line L2, so that when the low-level potential signal used to drive the first control signal (EM signal) has a potential fluctuation in units of the first control signal (EM signal) period, the low-level potential signal used to drive the second control signal (SPX signal) may not be coupled, so that the second control signal (SPX signal) may not have periodic coupling fluctuations, which may effectively reduce the display problem of bright and dark horizontal stripes of the display panel under low grayscale display, which may be conducive to improving display quality.

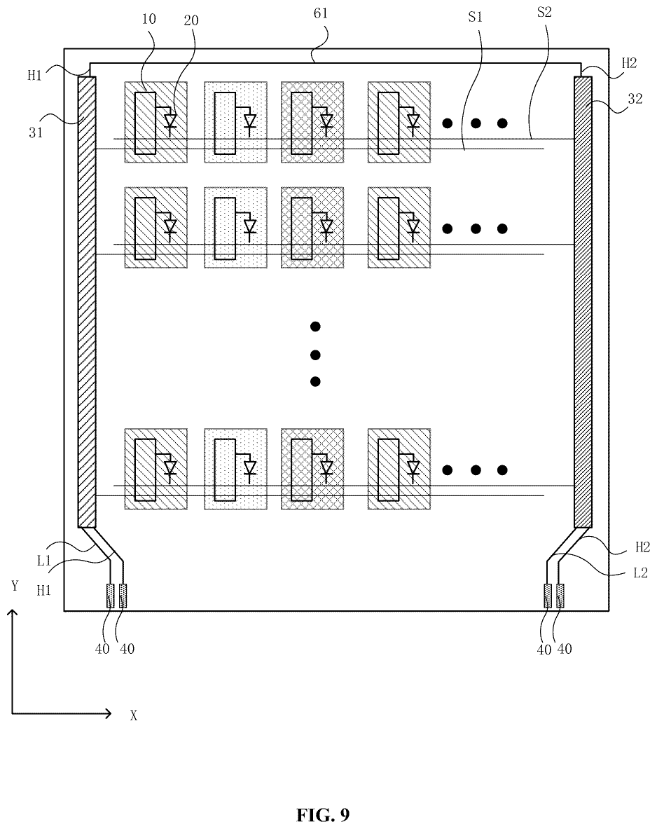

FIG. 9 is a planar schematic diagram of another exemplary display panel provided by the present disclosure. Referring to FIG. 2 and FIG. 9, in some embodiments, the first potential signal line L1 and the second potential signal line L2 may be both connected to a low-level signal, and the first shift register 31 may be electrically connected to the first high-level signal line H1, and the second shift register 32 may be electrically connected to the second high-level signal line H2. The first high-level signal line H1 and the second high-level signal line H2 may be connected to the same high-level potential.

Specifically, when the first potential signal line L1 and the second potential signal line L2 in the display panel are both connected to a low-level signal, the display panel may further include a first high-level signal line H1. The first high-level signal line H1 may be electrically connected to the first shift register 31, and the first high-level signal line H1 may be connected to a potential signal with a high-level potential, so that the potential signal may be transmitted to the first shift register 31 via the first high-level signal line H1. The first shift register 31 may generate a first control signal (EM signal) based on the signal including the potential signal, and may transmit the first control signal (EM signal) to the control terminal of the light-emitting control unit 12 via the first control line S1, thereby realizing the control of the state of the light-emitting control unit 12.

The display panel may also include a second high-level signal line H2, which may be electrically connected to the second shift register 32. The second high-level signal line H2 may be connected to a potential signal with a high potential, so that the potential signal may be transmitted to the second shift register 32 via the second high-level signal line H2. The second shift register 32 may generate a second control signal (SPX signal) based on the signal including the potential signal, and may transmit the second control signal (SPX signal) to the control terminal of the first control unit 13 via the second control line S2, so that the state of the first control unit 13 may be controlled.

The first high-level signal line H1 and the second high-level signal line H2 may have the same high-level potential, that is, the first high-level signal line H1 and the second high-level signal line H2 may share the same voltage setting. The high-level potential provided to the first high-level signal line H1 and the second high-level signal line H2 by the same voltage adjustment unit in the driver chip may be conducive to reducing the design difficulty of the driver chip and reducing the production cost of the driver chip.

Further, referring to FIG. 2 and FIG. 9, in some embodiments, the absolute values of the low-level signals connected to the first potential signal line L1 and the second potential signal line L2 may be same. Specifically, both the first potential signal line L1 and the second potential signal line L2 may be connected to a low-level signal, that is, the first potential signal line L1 may a signal line for connecting to a low-level potential signal, and at the same time, the second potential signal line L2 may also be a signal line for connecting to a low-level potential signal, and the first potential signal line L1 and the second potential signal line L2 may be disconnected, but the absolute values of the low-level signals connected to the first potential signal line L1 and the second potential signal line L2 may be same. Accordingly, the first potential signal line L1 and the second potential signal line L2 may be connected to the same low-level signal, that is, the first potential signal line L1 and the second potential signal line L2 may share the same set of voltage settings. Thus, the low-level potential may be provided to the first potential signal line L1 and the second potential signal line L2 by the same set of voltage regulation units in the driver chip, which may be conducive to reducing the design difficulty of the driver chip and reducing the production cost of the driver chip.

Further, referring to FIG. 9, the first high-level signal line H1 and the second high-level signal line H2 may be connected and arranged. Accordingly, the first high-level signal line H1 and the second high-level signal line H2 may be connected through the same soldering pad 40, which may be beneficial to reduce the number of pads 40, and may be beneficial to reduce the occupied area of the soldering pad 40, and improve the space utilization of the display panel.

In one embodiment, the first high-level signal line H1 and the second high-level signal line H 2 may be connected through a first connection line 61, and the first connection line 61 may be arranged on the side of the display panel away from the soldering pad 40 along the second direction Y, so as to avoid the arrangement of the first connection line 61 affecting the arrangement of the signal lines connected to each soldering pad 40.

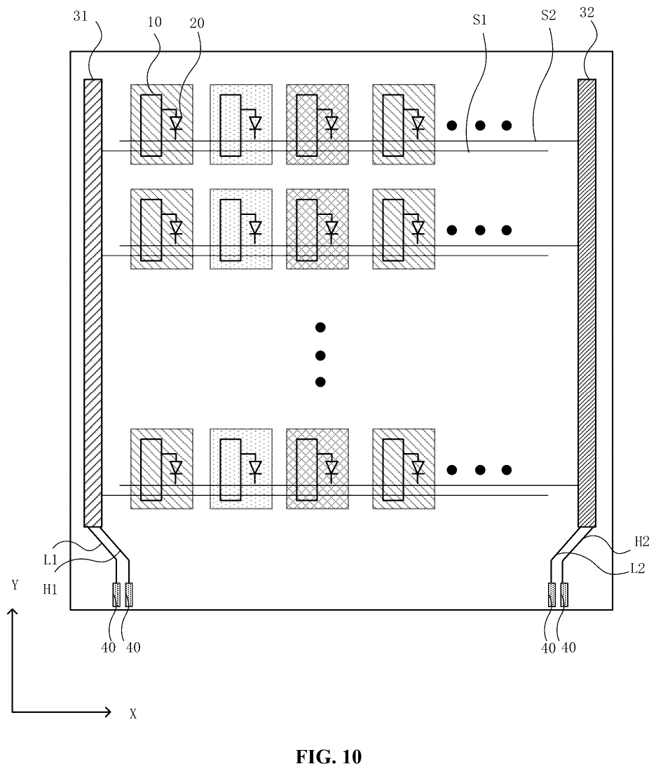

FIG. 10 is a top view of another exemplary display panel provided by one embodiment of the present disclosure. As shown in FIG. 10, in some embodiments, the first potential signal line L1 and the second potential signal line L2 may be both connected to a low-level signal. The first potential signal line L1 and the second potential signal line L2 may be disconnected. The first shift register 31 may be electrically connected to the first high-level signal line H1, the second shift register 32 may be electrically connected to the second high-level signal line H2, and the first high-level signal line H1 may be disconnected from the second high-level signal line H2.

Specifically, when the first potential signal line L1 and the second potential signal line L2 in the display panel are both connected to the low-level signals, the first high-level signal line H1 and the second high-level signal line H2 may be both be connected to the high-level signals, that is, the first high-level signal line H1 may be a signal line for connecting to the high-level potential signal, and at the same time, the second high-level signal line H2 may also be a signal line for connecting to the high-level potential signal. At this time, the first high-level signal line H1 and the second high-level signal line H2 may be disconnected, that is, the high-level potential signal transmitted on the first high-level signal line H1 may not affect the high-level potential signal transmitted on the second high-level signal line H2, so that when the high-level potential signal used to drive the first control signal (EM signal) has the voltage fluctuates with the first control signal (EM signal) period as a unit, the high-level potential signal used to drive the second control signal (SPX signal) may not be coupled. At the same time, the first potential signal line L1 and the second potential signal line L2 may be disconnected, that is, the low-level potential signal transmitted on the first potential signal line L1 may not affect the low-level potential signal transmitted on the second potential signal line L2. Therefore, when the low-level potential signal used to drive the first control signal (EM signal) has a potential fluctuation in units of the first control signal (EM signal) period, the low-level potential signal used to drive the second control signal (SPX signal) may not be coupled, so that the second control signal (SPX signal) may not have periodic coupling fluctuations, effectively reducing the display problem of bright and dark horizontal stripes of the display panel under low grayscale display, which may be conducive to improving display quality.

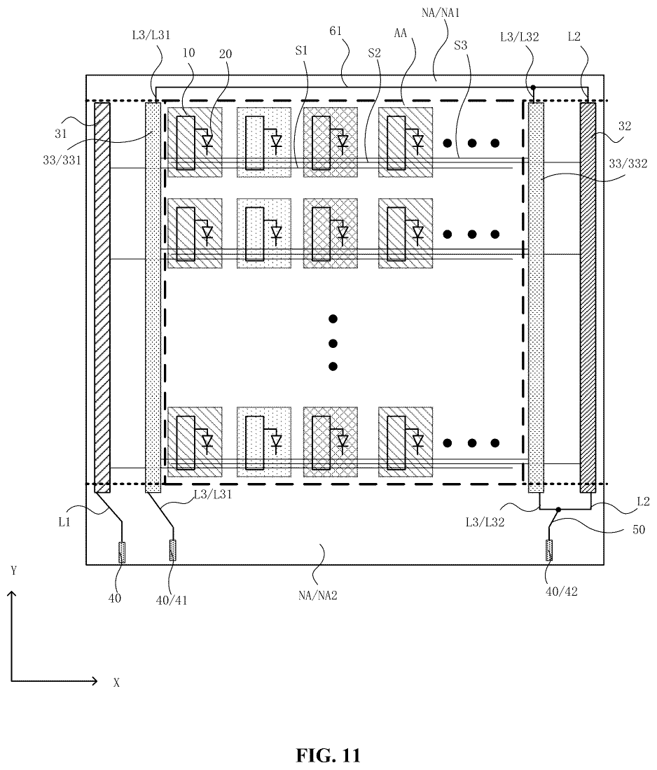

FIG. 11 is a planar schematic diagram of another exemplary display panel provided by one embodiment of the present disclosure. Referring to FIG. 2 and FIG. 11, in some embodiments, the pixel circuit 10 may further include a second control unit 14, and the control terminal of the second control unit 14 may be connected to the third control line S3. The display panel may further include a third shift register 33, and the output terminal of the third shift register 33 may be electrically connected to the third control line S3. The display panel may further include a third potential signal line L3, and the third potential signal line L3 may be electrically connected to the third shift register 33. The second potential signal line L2 and the third potential signal line L3 may be electrically connected, and the second potential signal line L2 and the third potential signal line L3 may be both connected to a high-level signal or both connected to a low-level signal.

Specifically, in the display panel, the first potential signal line L1 and the second potential signal line L2 may be both connected to a high-level signal or a low-level signal. At this time, the first potential signal line L1 and the second potential signal line L2 may be isolated from each other, that is, the potential signal transmitted on the first potential signal line L1 may not affect the potential signal transmitted on the second potential signal line L2. Therefore, when the potential signal used to drive the first control signal (EM signal) has a potential fluctuation in units of the first control signal (EM signal) period, the potential signal used to drive the second control signal (SPX signal) may not be coupled, so that the second control signal (SPX signal) may not have periodic coupling fluctuations, which may effectively reduce the display problem of bright and dark horizontal stripes in the display panel under low grayscale display, and which may be conducive to improving the display quality.

The pixel circuit 10 may also include a second control unit 14, and the control terminal of the second control unit 14 may be connected to the third control line S3. The display panel may also include a third shift register 33, and the output terminal of the third shift register 33 may be electrically connected to the third control line S3. The display panel may also include a third potential signal line L3, the third potential signal line L3 may be electrically connected to the third shift register 33, and the third potential signal line L3 may also be connected to the potential signal, so that the potential signal may be transmitted to the third shift register 33 via the third potential signal line L3. The third shift register 33 may generate a third control signal (SP signal) based on the signal including the potential signal, and transmit the third control signal (SP signal) to the control terminal of the second control unit 14 via the third control line S3, so that the state of the second control unit 14 may be controlled.

The first potential signal line L1, the second potential signal line L2 and the third potential signal line L3 may all be connected to a high-level signal or a low-level signal, that is, the second potential signal line L2 and the third potential signal line L3 are connected to the same signal, the first potential signal line L1, the second potential signal line L2 and the third potential signal line L3 are all connected to a high-level signal, or the first potential signal line L1, the second potential signal line L2 and the third potential signal line L3 are all connected to a low-level signal.

When the first potential signal line L1, the second potential signal line L2 and the third potential signal line L3 are all connected to a high-level signal, that is, the first potential signal line L1 may be a signal line for connecting a high-level potential signal, the second potential signal line L2 may be a signal line for connecting a high-level potential signal, and the third potential signal line L3 may also be a signal line for connecting a high-level potential signal, at this time, the second potential signal line L2 and the third potential signal line L3 may be electrically connected, that is, the third potential signal line L3 may be disconnected from the first potential signal line L1, so that when the potential signal used to drive the first control signal (EM signal) has the potential fluctuation with the unit of period of first control signal (EM signal), the potential signal used to drive the third control signal (SP signal) may not be coupled, so that the third control signal (SP signal) may not have periodic coupling fluctuations. At the same time, when the high-level signals required to be connected to the second potential signal line L2 and the third potential signal line L3 are the same, the second potential signal line L2 and the third potential signal line L3 may be electrically connected, so that the second potential signal line L2 and the third potential signal line L3 may be connected through the same soldering pad 40, which may be conducive to reducing the number of soldering pads 40, reducing the occupied area of soldering pads 40, and improving the space utilization of the display panel.

Similarly, when the first potential signal line L1, the second potential signal line L2 and the third potential signal line L3 are all connected to low-level signals, that is, the first potential signal line L1 may be a signal line for connecting to a low-level potential signal, the second potential signal line L2 may be a signal line for connecting to a low-level potential signal, and the third potential signal line L3 may also be a signal line for connecting to a low-level potential signal, at this time, the second potential signal line L2 and the third potential signal line L3 may be electrically connected, that is, the third potential signal line L3 may be disconnected from the first potential signal line L1, so that when the potential signal used to drive the first control signal (EM signal) have the potential fluctuation with the unit period of the first control signal (EM signal), the potential signal used to drive the third control signal (SP signal) may not be coupled, so that the third control signal (SP signal) may not have periodic coupling fluctuations. At the same time, when the low-level signals required to be connected to the second potential signal line L2 and the third potential signal line L3 are the same, the second potential signal line L2 and the third potential signal line L3 may be electrically connected, so that the second potential signal line L2 and the third potential signal line L3 may be connected through the same soldering pad 40, which may conducive to reducing the number of soldering pads 40, reducing the occupied area of the soldering pad 40, and improving the space utilization of the display panel.

In one embodiment, when the transistor electrically connected to the second control line S2 and the transistor electrically connected to the third control line S3 are of the same type, the high level required for the driving signal of the transistor electrically connected to the second control line S2 and the high level required for the driving signal of the transistor electrically connected to the third control line S3 may be same, and the low level required for the driving signal of the transistor electrically connected to the second control line S2 and the low level required for the driving signal of the transistor electrically connected to the third control line S3 may be same, so that the second potential signal line L2 and the third potential signal line L3 may be electrically connected.

Continuing to refer to FIG. 2 and FIG. 11, in some embodiments, the pixel circuit 10 may also include a data writing unit 141, which may be used to realize writing a data signal (DATA signal) into the driving unit 11. The second control unit 14 may include the data writing unit 141.

Specifically, the pixel circuit 10 may further include a data writing unit 141, and the second control unit 14 may include the data writing unit 141. The control terminal of the data writing unit 141 may be connected to the third control line S3, the first terminal of the data writing unit 141 may be connected to the DATA signal, the second terminal of the data writing unit 141 may connected to the driving unit 11, and the data writing unit 141 may be used to write the data signal (DATA signal) into the driving unit 11. The transistor T2 in the data writing unit 141 may be of the same type as the transistor T7 in the first reset unit 131, so that the voltage setting of the driving signal may be same for both. The second shift register 32 electrically connected to the second potential signal line L2 may be used to input the second control signal (SPX signal) to the first reset unit 131, the third shift register 33 electrically connected to the third potential signal line L3 may be used to input the third control signal (SP signal) to the data writing unit 141, and the second potential signal line L2 and the third potential signal line L3 may be electrically connected. At this time, the normal operation and reliability of the transistor T2 in the data writing unit 141 and the transistor T7 in the first reset unit 131 may not be affected.

Continuing to refer to FIG. 2 and FIG. 11, in some embodiments, the third shift register 33 may include a first sub-shift register 331 and a second sub-shift register 332, and the third potential signal line L3 may include a first sub-potential signal line L31 and a second sub-potential signal line L32. Along the first direction X, the first sub-shift register 331 and the second sub-shift register 332 may be respectively located on both sides of the display panel.

The first sub-shift register 331 may be electrically connected to the first sub-potential signal line L31, and the second sub-shift register 332 may be electrically connected to the second sub-potential signal line L32. Along the second direction Y, the first sub-potential signal line L31 and the second sub-potential signal line L32 may be connected on at least one side of the display panel. The first direction X and the second direction Y may intersect. In one embodiment, the first direction X and the second direction Y may be perpendicular to each other.

Specifically, the third shift register 33 may include a first sub-shift register 331 and a second sub-shift register 332, and the third potential signal line L3 may include a first sub-potential signal line L31 and a second sub-potential signal line L32. Along the first direction X, the first sub-shift register 331 and the second sub-shift register 332 may be respectively located on both sides of the display panel, and the first sub-shift register 331 and the second sub-shift register 332 may be both connected to the third control line S3. The third control line S3 connected to the pixel circuits 10 arranged in the same row along the first direction X may be electrically connected to the first sub-shift register 331 and the second sub-shift register 332 at the same time, that is, the data writing unit 141 in the pixel circuit 10 may be input with a third control signal (SP signal) through a dual driving structure, so that more pixel circuits 10 may be driven at the same time, reducing signal transmission delay and improving response speed.

The first sub-shift register 331 may be electrically connected to the first sub-potential signal line L31, and the second sub-shift register 332 may be electrically connected to the second sub-potential signal line L32. The first sub-shift register 331 and the second sub-shift register 332 may be used to simultaneously input the third control signal (SP signal) to the data writing unit 141 in the pixel circuit 10, so that the first sub-potential signal line L31 electrically connected to the first sub-shift register 331 and the second sub-potential signal line L32 electrically connected to the second sub-shift register 332 may be electrically connected. Along the second direction Y, the first sub-potential signal line L31 and the second sub-potential signal line L32 may be connected on at least one side of the display panel.

Further, referring to FIG. 2 and FIG. 11, in some embodiments, the display panel may include a display area AA and a non-display area NA surrounding the display area AA. The non-display area NA may include a first non-display area NA1 and a second non-display area NA2 located on opposite sides of the display area AA, and the second potential signal line L2 and the third potential signal line L3 may be electrically connected in the first non-display area NA1 and/or the second non-display area NA2.

Specifically, the display panel may include a display area AA and a non-display area NA surrounding the display area AA. The display area AA may be used for display, and the non-display area NA may not be used for display. The non-display area NA may be used to set structures such as a driving circuit, etc. The non-display area NA may include a first non-display area NA1 and a second non-display area NA2 located on opposite sides of the display area AA. The second potential signal line L2 and the third potential signal line L3 may be electrically connected in the first non-display area NA1 and/or the second non-display area NA2 through the first connection line 61, thereby realizing the electrical connection between the second potential signal line L2 and the third potential signal line L3, and at the same time, may not affect the setting of the display area AA.

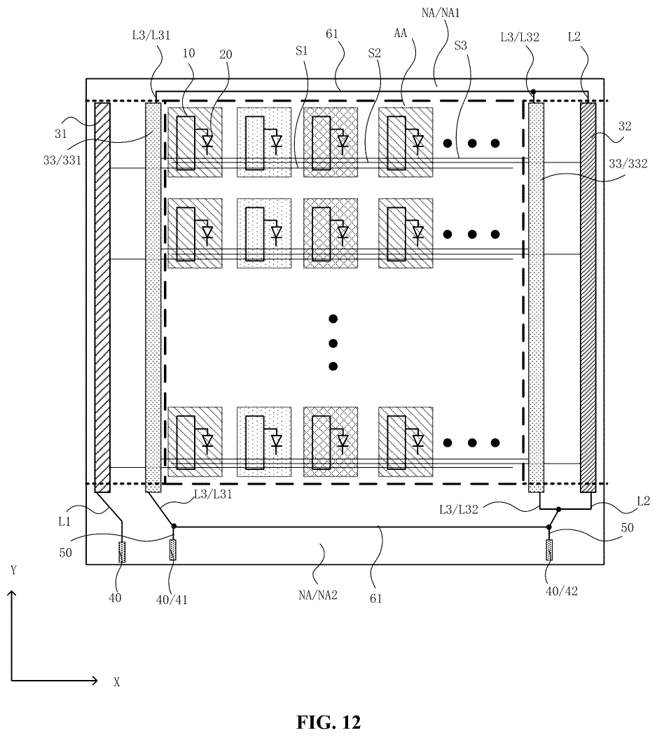

It should be noted that FIG. 11 exemplarily shows that the second potential signal line L2 and the third potential signal line L3 are electrically connected in the first non-display area NA1. In other embodiments of the present disclosure, referring to FIG. 12 that is a planar schematic diagram of another exemplary display panel provided by one embodiment of the present disclosure, the second potential signal line L2 and the third potential signal line L3 may be both electrically connected in the first non-display area NA1 and the second non-display area NA2. In some embodiments, the second potential signal line L2 and the third potential signal line L3 may also be electrically connected in the second non-display area NA2, thereby improving the stability and uniformity of the potential of each point in the second potential signal line L2 and the third potential signal line L3. The present disclosure will not be repeated here.

Further, referring to FIG. 12, in some embodiments, the first sub-potential signal line L31, the second sub-potential signal line L32 and the second potential signal line L2 may be electrically connected to the same first potential signal bus 50. Thus, the first sub-potential signal line L31 and the second sub-potential signal line L32 may be electrically connected to the second potential signal line L2, and the first sub-potential signal line L31 and the second sub-potential signal line L32 may be electrically connected to the second potential signal line L2 through the first signal bus 50, which may simplify the complex wiring design, save wiring space, and improve space utilization.

Further, referring to FIG. 11, in some embodiments, the display panel may include a plurality of soldering pads 40. The plurality of soldering pads 40 may include a first soldering pad 41 and a second soldering pad 42. The second potential signal line L2 and the third potential signal line L3 may be both electrically connected to the first soldering pad 41 and the second soldering pad 42. Along the first direction X, the first soldering pad 41 and the second soldering pad 42 may be respectively located at both ends of the display panel.

Specifically, the third shift register 33 may include a first sub-shift register 331 and a second sub-shift register 332, and the third potential signal line L3 may include a first sub-potential signal line L31 and a second sub-potential signal line L32. Along the first direction X, the first sub-shift register 331 and the second sub-shift register 332 may be respectively located on both sides of the display panel, the first sub-shift register 331 may be electrically connected to the first sub-potential signal line L31, and the second sub-shift register 332 may be electrically connected to the second sub-potential signal line L32. Accordingly, along the first direction X, a first soldering pad 41 and a second soldering pad 42 may be respectively provided at both ends of the display panel, and the second potential signal line L2 and the third potential signal line L3 may be both electrically connected to the first soldering pad 41 and the second soldering pad 42, so that signals may be transmitted from the first soldering pad 41 and the second soldering pad 42 to the second potential signal line L2 and the third potential signal line L3 at the same time, which may effectively reduce the voltage drop and improve the uniformity of the signals transmitted to the second potential signal line L2 and the third potential signal line L3.

In one embodiment, at least one of the first sub-potential signal line L31 and the second sub-potential signal line L32 and the second potential signal line L2 may be electrically connected to the same first signal bus 50. Exemplarily, referring to FIG. 11, when the second potential signal line L2 and the third potential signal line L3 are electrically connected in the first non-display area NA1 through the first connection line 61, the first sub-potential signal line L 31 may be electrically connected to the first soldering pad 41, and the second sub-potential signal line L32 and the second potential signal line L2 may be electrically connected to the second soldering pad 42 through the same first signal bus 50. In other embodiments of the present disclosure, it may also be set that the first sub-potential signal line L31 and the second potential signal line L2 are electrically connected to the same first signal bus 50, or the first sub-potential signal line L31 and the second sub-potential signal line L32 and the second potential signal line L2 may be electrically connected to the same first signal bus 50, and the present disclosure will not repeat here.

Further, referring to FIG. 11, in some embodiments, the second potential signal line L2 and the third potential signal line L3 may be both connected to the low-level potential.

Specifically, both the first potential signal line L1 and the second potential signal line L2 may be connected to low-level signals, that is, the first potential signal line L1 may be a signal line for connecting to a low-level potential signal, and at the same time, the second potential signal line L2 may also be a signal line for connecting to a low-level potential signal. At this time, the first potential signal line L1 and the second potential signal line L2 may be disconnected, that is, the low-level potential signal transmitted on the first potential signal line L1 may not affect the low-level potential signal transmitted on the second potential signal line L2, so that when the low-level potential signal used to drive the first control signal (EM signal) has a potential fluctuation in units of the first control signal (EM signal) period, the low-level potential signal used to drive the second control signal (SPX signal) may not be coupled, so that the second control signal (SPX signal) may not have periodic coupling fluctuations, effectively reducing the display problem of bright and dark horizontal stripes of the display panel under low grayscale display, which may be conducive to improving display quality.

At the same time, the third potential signal line L3 may also be connected to the low-level potential, that is, the third potential signal line L3 may also be a signal line for connecting to the low-level potential signal. When the low-level signals required to be connected to the second potential signal line L2 and the third potential signal line L3 are the same, the second potential signal line L2 and the third potential signal line L3 may be electrically connected, so that the second potential signal line L2 and the third potential signal line L3 may be connected through a same soldering pad 40, which may be conducive to reducing the number of soldering pads 40, and may be conducive to reducing the occupied area of the soldering pad 40, and improving the space utilization of the display panel.

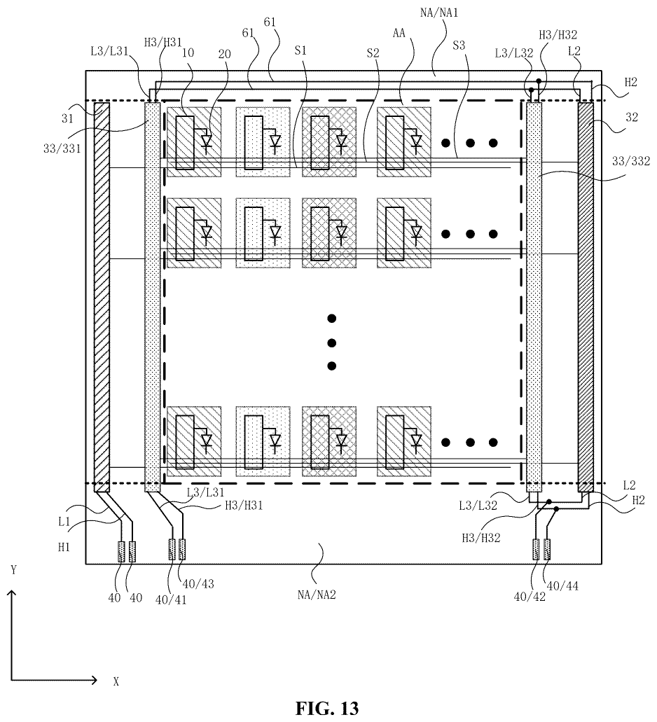

FIG. 13 is a planar schematic diagram of another exemplary display panel provided by one embodiment of the present disclosure. Referring to FIG. 2 and FIG. 13, in some embodiments, the first shift register 31 may be electrically connected to the first high-level signal line H1, the second shift register 32 may be electrically connected to the second high-level signal line H2, the third shift register 33 may be electrically connected to the third high-level signal line H3, and the first high-level signal line H1 may be disconnected from the second high-level signal line H2 and the third high-level signal line H3.

Specifically, both the first high-level signal line H1 and the second high-level signal line H2 may be connected to high-level signals, that is, the first high-level signal line H1 may be a signal line for connecting to a high-level potential signal, and at the same time, the second high-level signal line H2 may also be a signal line for connecting to a high-level potential signal. At this time, the first high-level signal line H1 and the second high-level signal line H2 may be disconnected, that is, the high-level potential signal transmitted on the first high-level signal line H1 may not affect the high-level potential signal transmitted on the second high-level signal line H2, so that when the high-level potential signal used to drive the first control signal (EM signal) has a potential fluctuation in units of the first control signal (EM signal) period, the high-level potential signal used to drive the second control signal (SPX signal) may not be coupled, so that the second control signal (SPX signal) may not have periodic coupling fluctuations, which may effectively improve the display problem of bright and dark horizontal stripes of the display panel under low grayscale display, and which may be conducive to improving display quality.

The third high-level signal line H3 may be connected to a high-level signal, that is, the third high-level signal line H3 may also be a signal line for connecting a high-level potential signal. The first high-level signal line H1 may be disconnected from the third high-level signal line H3, that is, the high-level potential signal transmitted on the first high-level signal line H1 may not affect the high-level potential signal transmitted on the third high-level signal line H3, so that when the high-level potential signal used to drive the first control signal (EM signal) has a potential fluctuation in units of the first control signal (EM signal) cycle, it may not affect the signal on the third high-level signal line H3.

Further, referring to FIG. 2 and FIG. 13, in some embodiments, the second potential signal line L2 and the third potential signal line L3 may be electrically connected, and the second high-level signal line H2 and the third high-level signal line H3 may be electrically connected.

Specifically, the second potential signal line L2 and the third potential signal line L3 may be both connected to low-level signals, that is, the second potential signal line L2 may be a signal line for connecting to a low-level potential signal, and the third potential signal line L3 may also be a signal line for connecting to a low-level potential signal. When the low-level signals required to be connected to the second potential signal line L2 and the third potential signal line L3 are same, the second potential signal line L2 and the third potential signal line L3 may be electrically connected, so that the second potential signal line L2 and the third potential signal line L3 may be connected through the same soldering pad 40, which may be conducive to reducing the number of soldering pads 40, reducing the occupied area of the soldering pads 40, and improving the space utilization of the display panel.

Similarly, the second high-level signal line H2 and the third high-level signal line H3 may be both connected to high-level signals, that is, the second high-level signal line H2 may be a signal line for connecting to a high-level potential supply signal, and the third high-level signal line H3 may also be a signal line for connecting to the high-level potential supply signal. When the high-level signals to be connected to the second high-level signal line H2 and the third high-level signal line H3 are same, the second high-level signal line H2 and the third high-level signal line H3 may be electrically connected, so that the second high-level signal line H2 and the third high-level signal line H3 may be connected through the same soldering pad 40, which may be conducive to reducing the number of soldering pads 40, and may be conducive to reducing the occupied area of the soldering pad 40, and improving the space utilization of the display panel.

Further, referring to FIG. 13, in some embodiments, the soldering pads 40 may include a third soldering pad 43 and a fourth soldering pad 44, and the second high-level signal line H2 and the third high-level signal line H3 may be both electrically connected to the third soldering pad 43 and the fourth soldering pad 44. Along the first direction X, the third soldering pad 43 and the fourth soldering pad 44 may be respectively located at both ends of the display panel.

Specifically, the third shift register 33 may include a first sub-shift register 331 and a second sub-shift register 332, and the third potential signal line L3 may include a first sub-potential signal line L31 and a second sub-potential signal line L32. Along the first direction X, the first sub-shift register 331 and the second sub-shift register 332 may be respectively located on both sides of the display panel. The third high-level signal line H3 may include a third sub-potential signal line H31 and a fourth sub-potential signal line H32. The first sub-shift register 331 may be electrically connected to the third sub-potential signal line H31, and the second sub-shift register 331 may be electrically connected to the third sub-potential signal line H31. The device 332 may be electrically connected to the fourth sub-potential signal line H32. Accordingly, along the first direction X, the third soldering pad 43 and the fourth soldering pad 44 may be respectively provided at both ends of the display panel. The second high-level signal line H2 and the third high-level signal line H3 may be both electrically connected to the third soldering pad 43 and the fourth soldering pad 44. The signal may be transmitted from the third soldering pad 43 and the fourth soldering pad 44 to the second high-level signal line H2 and the third high-level signal line H3 at the same time, which may effectively reduce the voltage drop and improve the uniformity of the signal transmitted to the second high-level signal line H2 and the third high-level signal line H3.

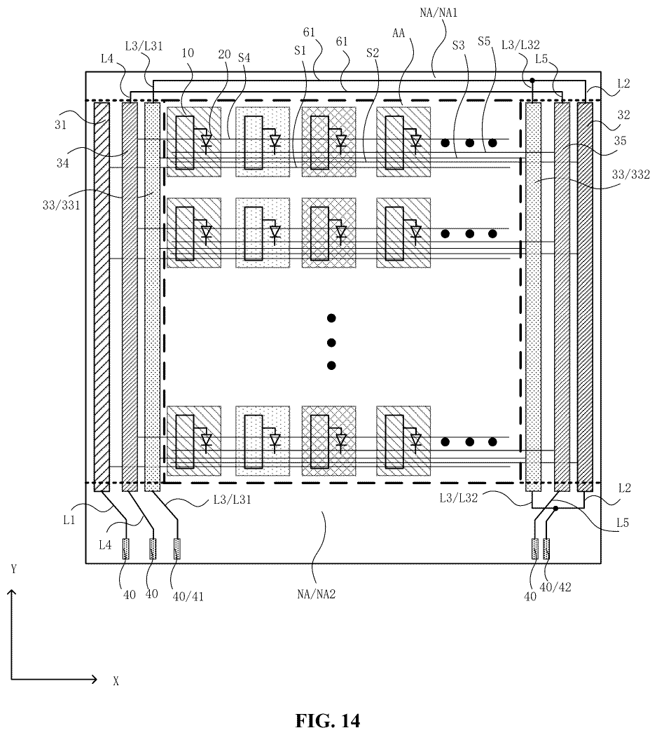

FIG. 14 is a planar schematic diagram of another exemplary display panel provided by one embodiment of the present disclosure. Referring to FIG. 2 and FIG. 14, in some embodiments, the pixel circuit 10 may further include a third control unit 15 and a fourth control unit 16. The control terminal of the third control unit 15 may be electrically connected to the fourth control line S4, and the control terminal of the fourth control unit 16 may be electrically connected to the fifth control line S5.

The display panel may further include a fourth shift register 34 and a fifth shift register 35. The output terminals of the fourth shift register 34 and the fifth shift register 35 may be electrically connected to the fourth control line S4 and the fifth control line S5, respectively.

The display panel may further include a fourth potential signal line LA and a fifth potential signal line L5. The fourth potential signal line LA and the fifth potential signal line L5 may be electrically connected to the fourth shift register 34 and the fifth shift register 35, respectively. The first potential signal line L1 may be disconnected from the fourth potential signal line LA and the fifth potential signal line L5, and the fourth and fifth potential signal lines (L4, L5) and the first potential signal line L1 may all be connected to high-level signals or low-level signals.

Specifically, the pixel circuit 10 may further include a third control unit 15. The control terminal of the third control unit 15 may be electrically connected to the fourth control line S4. The display panel may further include a fourth shift register 34. The output terminal of the fourth shift register 34 may be electrically connected to the fourth control line S4. The display panel may further include a fourth potential signal line L4. The fourth potential signal line LA may be electrically connected to the fourth shift register 34. The fourth potential signal line LA may also be connected to the potential signal, so that the potential signal may be transmitted to the fourth shift register 34 via the fourth potential signal line LA. The fourth shift register 34 may generate a fourth control signal (S2N signal) based on the signal including the potential signal, and may transmit the fourth control signal (S2N signal) to the control terminal of the third control unit 15 via the fourth control line S4, so that the state of the third control unit 15 may be controlled.

The pixel circuit 10 may also include a fourth control unit 16. The control terminal of the fourth control unit 16 may be electrically connected to the fifth control line S5. The display panel may also include a fifth shift register 35. The output terminal of the fifth shift register 35 may be electrically connected to the fifth control line S5. The display panel may also include a fifth potential signal line L5. The fifth potential signal line L5 may be electrically connected to the fifth shift register 35. The fifth potential signal line L5 may also be connected to the potential signal, so that the potential signal may be transmitted to the fifth shift register 35 via the fifth potential signal line L5. The fifth shift register 35 may generate a fifth control signal (S1N signal) based on the signal including the potential signal, and may transmit the fifth control signal (S1N signal) to the control terminal of the fourth control unit 16 via the fifth control line S5, so that the state of the fourth control unit 16 may be controlled.

The fourth potential signal line L4, the fifth potential signal line L5 and the first potential signal line L1 may all be connected to high-level signals or low-level signals, that is, the fourth potential signal line L4, the fifth potential signal line L5 and the first potential signal line L1 may be connected to a same signal. The fourth potential signal line LA, the fifth potential signal line L5 and the first potential signal line L1 may all be connected to high-level signals, or the fourth potential signal line LA, the fifth potential signal line L5 and the first potential signal line L1 may all be connected to low-level signals.

When the fourth potential signal line LA, the fifth potential signal line L5 and the first potential signal line L1 are all connected to high-level signals, that is, the first potential signal line L1 may be a signal line for connecting to a high-level potential signal, and the fourth potential signal line LA and the fifth potential signal line L5 may also be signal lines for connecting to a high-level potential signal. At this time, the first potential signal line L1 and the fourth potential signal line LA, and the first potential signal line L1 and the fifth potential signal line L5 may be disconnected to prevent the signal on the first potential signal line L1 from affecting the signals on the fourth potential signal line LA and the fifth potential signal line L5.

Similarly, when the fourth potential signal line L4, the fifth potential signal line L5 and the first potential signal line L1 are all connected to low-level signals, that is, the first potential signal line L1 may be a signal line for connecting to low-level potential signals, and the fourth potential signal line L4 and the fifth potential signal line L5 may also be signal lines for connecting to low-level potential signals. At this time, the first potential signal line L1 and the fourth potential signal line L4, and the first potential signal line L1 and the fifth potential signal line L5 may be disconnected to prevent the signal on the first potential signal line L1 from affecting the signal on the fourth potential signal line LA and the fifth potential signal line L5.

Further, referring to FIG. 2 and FIG. 14, in some embodiments, the pixel circuit 10 may also include a threshold compensation unit 151 and a gate reset unit 161. The threshold compensation unit 151 and the gate reset unit 161 may be electrically connected to the driving unit 11. The third control unit 15 may include the threshold compensation unit 151, and the fourth control unit 16 may include the gate reset unit 161.

Specifically, the pixel circuit 10 may further include a threshold compensation unit 151 and a gate reset unit 161. The control terminal of the threshold compensation unit 151 may be electrically connected to the fourth control line S4, and the control terminal of the gate reset unit 161 may be electrically connected to the fifth control line S5.

In one embodiment, the transistors included in the threshold compensation unit 151 and the gate reset unit 161 may be oxide transistors, that is, the transistor T4 in the threshold compensation unit 151 and the transistor T5 in the gate reset unit 161 may both be oxide transistors. In one embodiment, the transistor T4 in the threshold compensation unit 151 and the transistor T5 in the gate reset unit 161 may be both N-type metal oxide transistors, such as indium gallium zinc oxide (IGZO) transistors.

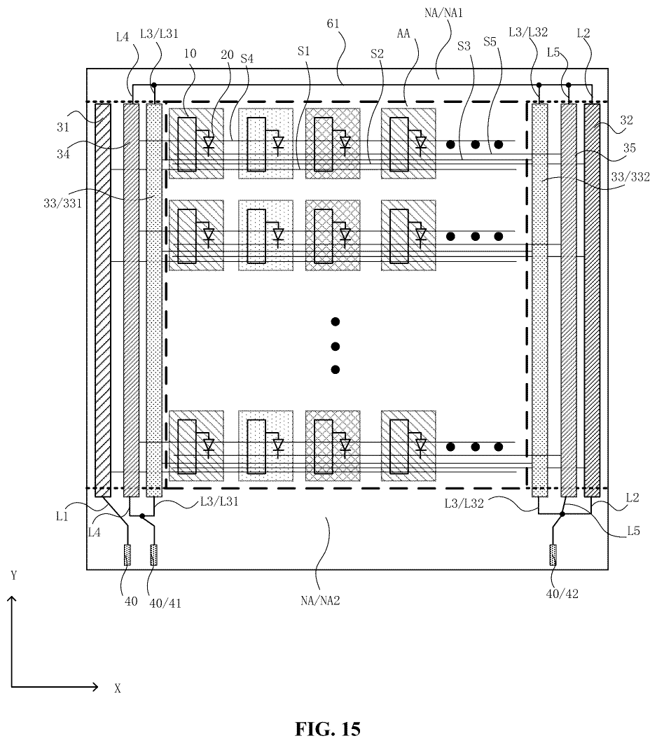

FIG. 15 is a planar schematic diagram of another exemplary display panel provided by one embodiment of the present disclosure. As shown in FIG. 15, in some embodiments, at least two of the second potential signal line L2, the third potential signal line L3, the fourth potential signal line LA and the fifth potential signal line L5 may be electrically connected.

Specifically, when the second potential signal line L2, the third potential signal line L3, the fourth potential signal line LA and the fifth potential signal line L5 are all connected to high-level signals or low-level signals, at least two of the second signal line L2, the third potential signal line L3, the fourth potential signal line LA and the fifth potential signal line L5 may be electrically connected, so that the second potential signal line L2, the third potential signal line L3, the fourth potential signal line LA and the fifth potential signal line L5 may be electrically connected to the driver chip by setting fewer soldering pads 40. In one embodiment, the second potential signal line L2, the third potential signal line L3, the fourth potential signal line L4 and the fifth potential signal line L5 may be electrically connected, so that the second potential signal line L2, the third potential signal line L3, the fourth potential signal line L4 and the fifth potential signal line L5 may be connected through the same soldering pad 40, which may be conducive to reducing the number of soldering pads 40, reducing the occupied area of the soldering pads 40, and improving the space utilization of the display panel. At the same time, the second potential signal line L2, the third potential signal line L3, the fourth potential signal line LA and the fifth potential signal line L5 may share the same set of voltage settings. The potential signal provided to the second potential signal line L2, the third potential signal line L3, the fourth potential signal line LA and the fifth potential signal line L5 by the same set of voltage regulation units in the driver chip may be conducive to reducing the design difficulty of the driver chip and reducing the production cost of the driver chip.

Further, referring to FIG. 2 and FIG. 14, in some embodiments, the second potential signal line L2 and the third potential signal line L3 may be electrically connected, the fourth potential signal line LA and the fifth potential signal line L5 may be electrically connected, and the third potential signal line L3 and the fourth potential signal line LA may be disconnected.

Specifically, the transistor T2 in the data writing unit 141 may be of the same type as the transistor T7 in the first reset unit 131, so the voltage setting of the driving signal may be the same for both. The second shift register 32 electrically connected to the second potential signal line L2 may be used to input the second control signal (SPX signal) to the first reset unit 131, and the third shift register 33 electrically connected to the third potential signal line L3 may be used to input the third control signal (SP signal) to the data writing unit 141. The second potential signal line L2 and the third potential signal line L3 may be electrically connected. At this time, the normal operation and reliability of the transistor T2 in the data writing unit 141 and the transistor T7 in the first reset unit 131 may not be affected.

The transistor T4 in the threshold compensation unit 151 and the transistor T5 in the gate reset unit 161 may be of the same type, so the voltage setting of the driving signal may be the same for both. The fourth shift register 34 electrically connected to the fourth potential signal line LA may be used to input the fourth control signal (S2N signal) to the threshold compensation unit 151, and the fifth shift register 35 electrically connected to the fifth potential signal line L5 may be used to input the fifth control signal (S1N signal) to the gate reset unit 161. The fourth potential signal line L4 and the fifth potential signal line L5 may be electrically connected. At this time, the normal operation and reliability of the transistor T4 in the threshold compensation unit 151 and the transistor T5 in the gate reset unit 161 may not be affected.

The transistor T7 in the first reset unit 131 and the transistor T4 in the threshold compensation unit 151 may be of different types. The fourth shift register 34 electrically connected to the fourth potential signal line LA may be used to input the fourth control signal (S2N signal) to the threshold compensation unit 151. The third shift register 33 electrically connected to the third potential signal line L3 may be used to input the third control signal (SP signal) to the data writing unit 141. The fourth potential signal line L4 and the third potential signal line L3 may be disconnected, so that the signals connected to the third potential signal line L3 and the fourth potential signal line LA may be controlled separately, which may ensure the normal operation and reliability of the transistor T7 in the first reset unit 131 and the transistor T4 in the threshold compensation unit 151.

Further, referring to FIG. 14, in some embodiments, the first to fifth potential signal lines (L1-L5) may be connected to low-level signals.

Specifically, the first to fifth potential signal lines (L1-L5) may all be connected to low-level signals, that is, the first to fifth potential signal lines (L1-L5) may all be signal lines for connecting to low-level potential signals. At this time, the first potential signal line L1 and the second to fifth potential signal lines (L2-L5) may be disconnected, that is, the low-level potential signal transmitted on the first potential signal line L1 may not affect the low-level potential signal transmitted on the second to fifth potential signal lines (L2-L5), so that when the low-level potential signal used to drive the first control signal (EM signal) has a potential fluctuation in units of the first control signal (EM signal) period, the low-level potential signal used to drive other control signals may not be coupled, so that other control signals may not have periodic coupling fluctuations, effectively reducing the display problem of bright and dark horizontal stripes of the display panel under low grayscale display, which may be conducive to improving display quality.

It should be noted that the low-level signals connected to the first to fifth potential signal lines (L1-L5) may be completely the same, partially the same, or completely different, and may be set according to actual design requirements, and the present disclosure does not repeat.

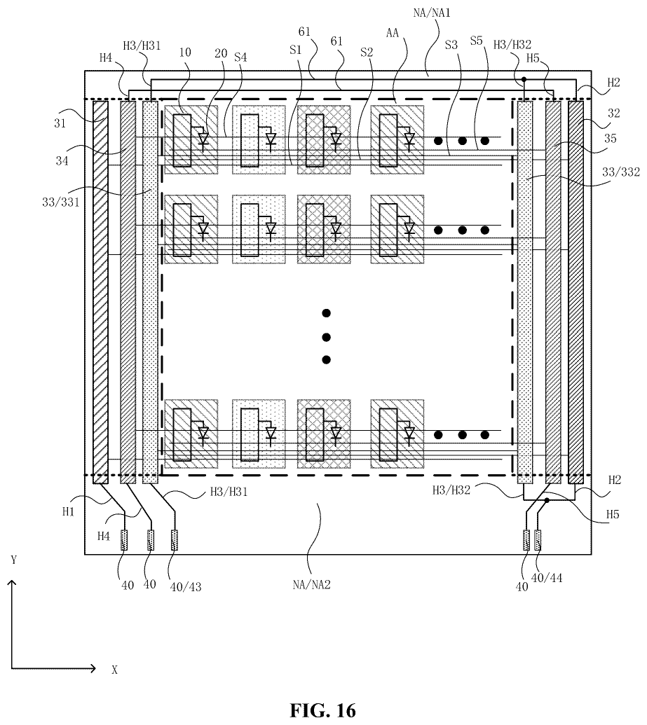

FIG. 16 is a plan schematic diagram of another exemplary display panel provided by one embodiment of the present disclosure. As shown in FIG. 16, in some embodiments, the display panel may also include first to fifth high-level signal lines (H1-H5). The first to fifth shift registers (31-35) may be electrically connected to the first to fifth high-level signal lines (H1-H5), respectively, and the first high-level signal line H1 may be disconnected from the second to fifth high-level signal lines (H2-H5).

Specifically, the display panel may further include first to fifth high-level signal lines (H1-H5). The first to fifth shift registers (31-35) may be electrically connected to the first to fifth high-level signal lines (H1-H5), and the first to fifth high-level signal lines (H1-H5) may all be signal lines for accessing high-level potential supply signals. At this time, the first high-level signal line H1 may be disconnected from the remaining high-level signal lines (H2-H5), that is, the high-level potential supply signal transmitted on the first high-level signal line H1 may not affect the high-level potential supply signal transmitted on the second to fifth high-level signal lines (H2-H5), so that when the high-level potential supply signal used to drive the first control signal (EM signal) has a potential fluctuation in units of the first control signal (EM signal) period, the high-level potential supply signal used to drive other control signals may not be coupled, so that other control signals may not have periodic coupling fluctuations, effectively reducing the display problem of bright and dark horizontal stripes of the display panel under low grayscale display, which may be conducive to improving display quality.

It should be noted that the high-level signals connected to the first to fifth high-level signal lines (H1-H5) may be completely the same, partially the same, or completely different, and may be set according to actual design requirements, which will not be described in detail in this disclosure.

It should be noted that, to clearly illustrate the arrangement of the first to fifth high-level signal lines (H1-H5) in FIG. 16, the first to fifth potential signal lines (L1-L5) are not shown in FIG. 16. The arrangement of the first to fifth potential signal lines (L1-L5) in the display panel may refer to the arrangement of the first to fifth potential signal lines (L1-L5) in FIG. 14 and FIG. 15, which will not be described in detail in this disclosure.

Further, referring to FIG. 2 and FIG. 16, in some embodiments, the second high-level signal line H2 may be electrically connected to the third high-level signal line H3, the fourth high-level signal line H4 may be electrically connected to the fifth high-level signal line H5, and the third high-level signal line H3 may be disconnected from the fourth high-level signal line H4.

Specifically, the transistor T2 in the data writing unit 141 may be of the same type as the transistor T7 in the first reset unit 131, so the voltage setting of the driving signal may be the same for both. The second shift register 32 electrically connected to the second high-level signal line H2 may be used to input the second control signal (SPX signal) to the first reset unit 131, and the third shift register 33 electrically connected to the third high-level signal line H3 may be used to input the third control signal (SP signal) to the data writing unit 141. The second high-level signal line H2 may be electrically connected to the third high-level signal line H3. At this time, the normal operation and reliability of the transistor T2 in the data writing unit 141 and the transistor T7 in the first reset unit 131 may not be affected.

The transistor T4 in the threshold compensation unit 151 and the transistor T5 in the gate reset unit 161 may be of the same type, so the voltage setting of the driving signal may be the same for both. The fourth shift register 34 electrically connected to the fourth high-level signal line H4 may be used to input the fourth control signal (S2N signal) to the threshold compensation unit 151, and the fifth shift register 35 electrically connected to the fifth high-level signal line H5 may be used to input the fifth control signal (S1N signal) to the gate reset unit 161. The fourth high-level signal line H4 may be electrically connected to the fifth high-level signal line H5. At this time, the normal operation and reliability of the transistor T4 in the threshold compensation unit 151 and the transistor T5 in the gate reset unit 161 may not be affected.

The transistor T7 in the first reset unit 131 and the transistor T4 in the threshold compensation unit 151 may be of different types. The fourth shift register 34 electrically connected to the fourth high-level signal line H4 may be used to input the fourth control signal (S2N signal) to the threshold compensation unit 151. The third shift register 33 electrically connected to the third high-level signal line H3 may be used to input the third control signal (SP signal) to the data writing unit 141. The third high-level signal line H3 and the fourth high-level signal line H4 may be disconnected, so that the signals connected to the third high-level signal line H3 and the fourth high-level signal line H4 may be controlled separately, which may ensure the normal operation and reliability of the transistor T7 in the first reset unit 131 and the transistor T4 in the threshold compensation unit 151.

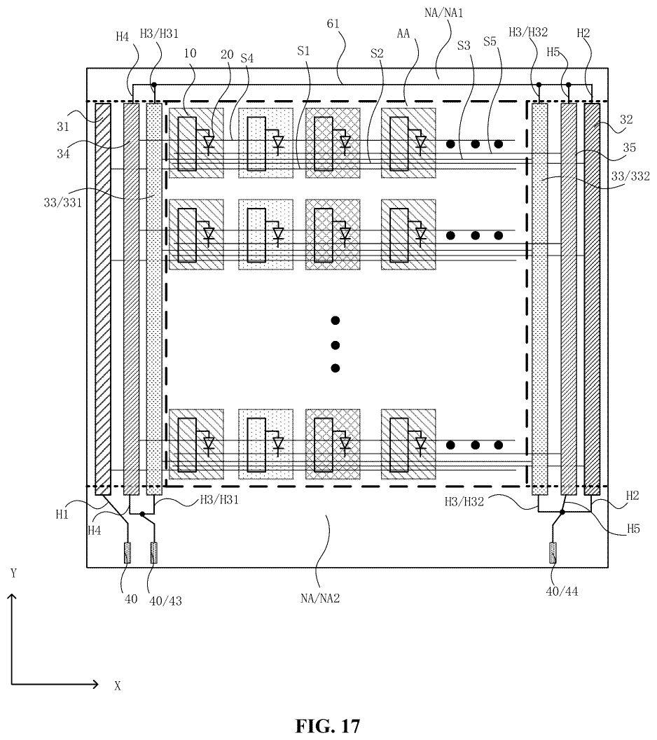

FIG. 17 is a planar schematic diagram of another exemplary display panel provided by one embodiment of the present disclosure. As shown in FIG. 17, in some embodiments, the second high-level signal line H2, the third high-level signal line H3, the fourth high-level signal line H4 and the fifth high-level signal line H5 may be electrically connected.

Specifically, the second high-level signal line H2, the third high-level signal line H3, the fourth high-level signal line H4 and the fifth high-level signal line H5 may all be connected to the high-level signal, and the second high-level signal line H2, the third high-level signal line H3, the fourth high-level signal line H4 and the fifth high-level signal line H5 may be electrically connected, so that the second high-level signal line H2, the third high-level signal line H3, the fourth high-level signal line H4 and the fifth high-level signal line H5 may be connected through the same soldering pad 40, which may be conducive to reducing the number of soldering pads 40, and may be conducive to reducing the occupied area of the soldering pad 40, and improving the space utilization rate of the display panel. At the same time, the second high-level signal line H2, the third high-level signal line H3, the fourth high-level signal line H4 and the fifth high-level signal line H5 may share the same set of voltage settings. When the potential supply signal provided to the second high-level signal line H2, the third high-level signal line H3, the fourth high-level signal line H4 and the fifth high-level signal line H5 are a same set of voltage adjustment units in the driver chip, it may be conducive to reducing the design difficulty of the driver chip and reducing the production cost of the driver chip.

It should be noted that, to clearly illustrate the arrangement of the first to fifth high-level signal lines (H1-H5) in FIG. 17, the first to fifth potential signal lines (L1-L5) are not shown in FIG. 17. The arrangement of the first to fifth potential signal lines (L1-L5) in the display panel may refer to the arrangement of the first to fifth potential signal lines (L1-L5) in FIG. 14 and FIG. 15, and the present disclosure will not repeat them here.

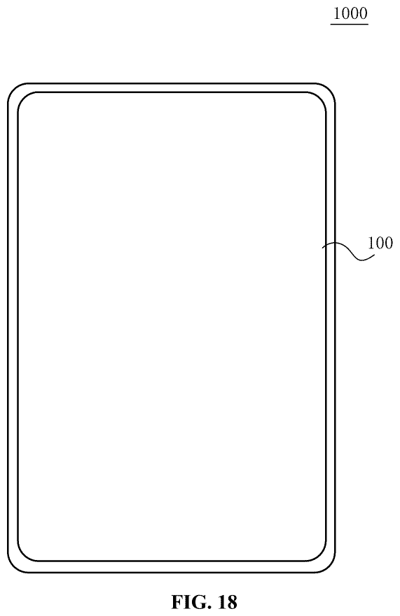

The present disclosure also provides a display device. FIG. 18 is a planar schematic diagram of an exemplary display device provided be one embodiment of the present disclosure.

As shown in FIG. 18, the display device 1000 may include a display panel 100 provided in any of the above embodiments. The display device may also include a housing for providing mechanical support and protection, a potential management unit located in the housing, and an audio output unit, etc. The embodiment provided in FIG. 18 only takes a mobile phone as an example to illustrate the display device. It can be understood that the display device provided in the embodiment of the present disclosure may be any electronic product with a display function, including but not limited to the following categories: mobile phones, televisions, laptops, desktop displays, tablet computers, digital cameras, smart bracelets, smart glasses, car displays, medical equipment, industrial control equipment, touch interactive terminals, etc., and the embodiment of the present disclosure does not specifically limit this.

The display device 1000 provided in the embodiment of the present disclosure may have the same technical features as the display panel 100 provided in the above embodiment, so it may also solve the same technical problems and achieve the same technical effects.

The technical solution provided by the present disclosure may have the following advantages. In the display panel provided by the present disclosure, the first potential signal line and the second potential signal line may be isolated from each other, that is, the first potential signal line and the second potential signal line may be disconnected, that is, the potential signal transmitted on the first potential signal line may not affect the potential signal transmitted on the second potential signal line, so that when the potential signal used to drive the first control signal has a potential fluctuation in units of the first control signal period, the potential signal used to drive the second control signal may not be coupled, so that the second control signal may not have periodic coupling fluctuations, effectively reducing the display problem of bright and dark horizontal stripes of the display panel under low grayscale display, which may be conducive to improving the display quality. Correspondingly, the display device provided by the present disclosure may also have the above technical effects.

It should be noted that in this article, relational terms such as “first” and “second” are only used to distinguish one entity or operation from another entity or operation, and do not necessarily require or imply that there is any such actual relationship or order between these entities or operations. Moreover, the terms “include”, “comprise” or any other variants thereof are intended to cover non-exclusive inclusion, so that a process, method, article or device including a series of elements includes not only those elements, but also other elements not explicitly listed, or may also include elements inherent to such a process, method, article or device. In the absence of further restrictions, an element defined by the sentence “comprising a . . . ” may not exclude the presence of other identical elements in the process, method, article or device comprising the element.

The above is only a specific implementation of the present disclosure, so that those skilled in the art can understand or implement the present disclosure. Various modifications to these embodiments will be obvious to those skilled in the art, and the general principles defined herein may be implemented in other embodiments without departing from the spirit or scope of the present disclosure. Therefore, the present disclosure will not be limited to the embodiments described herein, but will conform to the widest scope consistent with the principles and novel features disclosed herein.

1. A display panel, comprising:
a pixel circuit;
a light-emitting element electrically connected with the pixel circuit;
a first shift register;
a second shift register;
a first potential signal line; and
a second potential signal line,
wherein:
the pixel circuit includes a driving unit, a light-emitting control unit and a first control unit, a control terminal of the light-emitting control unit is connected to a first control line, and a control terminal of the first control unit is connected to a second control line;
an output terminal of the first shift register is electrically connected to the first control line, and an output terminal of the second shift register is electrically connected to the second control line;
the first potential signal line is electrically connected to the first shift register and is configured to supply a first power supply voltage to the first shift register, the second potential signal line is electrically connected to the second shift register and is configured to supply a second power supply voltage to the second shift register, and the first potential signal line and the second potential signal line are isolated from each other;
the first potential signal line and the second potential signal line are both connected to high-level signals or both connected to low-level signals; and
the first shift register is configured to generate a first control signal based on at least the first power supply voltage received from the first potential signal line and output the first control signal to the light-emitting control unit via the first control line, and the second shift register is configured to generate a second control signal based on at least the second power supply voltage received from the second potential signal line and output the second control signal to the first control unit via the second control line.

2. The display panel according to claim 1, wherein the first control unit comprises:
a bias adjustment unit electrically connected to the driving unit and configured to implement a bias adjustment on the driving unit.
wherein a control terminal of the bias adjustment unit is connected to the second control line, a first terminal of the bias adjustment unit is connected to a bias voltage supply signal, and a second terminal of the bias adjustment unit is electrically connected to the driving unit.

3. The display panel according to claim 2, wherein:
the first potential signal line and the second potential signal line are both connected to low-level signals.

4. The display panel according to claim 3, wherein:
the first shift register is electrically connected to a first high-level signal line;
the second shift register is electrically connected to a second high-level signal line; and
a high-level potential connected to the first high-level signal line is same as a high-level signal connected to the second high-level signal line.

5. The display panel according to claim 4, wherein:
absolute values of the low-level signals connected to the first potential signal line and the second potential signal line are same.

6. The display panel according to claim 3, wherein:
the first shift register is electrically connected to a first high-level signal line;
the second shift register is electrically connected to a second high-level signal line; and
the first high-level signal line is disconnected from the second high-level signal line.

7. The display panel according to claim 2, wherein:
the pixel circuit also includes a second control unit
with a control terminal being electrically connected to a third control line;
the display panel also includes a third shift register with an output terminal being electrically connected to the third control line;
the display panel also includes a third potential signal line electrically connected to the third shift register;
the second potential signal line is electrically connected to the third potential signal line; and
the second potential signal line and the third potential signal line are both connected to high-level signals or low-level signals.

8. The display panel according to claim 7, wherein:
the pixel circuit also includes a data writing unit configured to write data signals into the driving unit; and
the second control unit includes the data writing unit.

9. A display panel comprising:
a pixel circuit;
a light-emitting element electrically connected with the pixel circuit;
a first shift register;
a second shift register;
a first potential signal line; and
a second potential signal line,
wherein:
the pixel circuit includes a driving unit, a light-emitting control unit and a first control unit, a control terminal of the light-emitting control unit is connected to a first control line, and a control terminal of the first control unit is connected to a second control line;
an output terminal of the first shift register is electrically connected to the first control line, and an output terminal of the second shift register is electrically connected to the second control line;
the first potential signal line is electrically connected to the first shift register, the second potential signal line is electrically connected to the second shift register, and the first potential signal line and the second potential signal line are isolated from each other;
the first potential signal line and the second potential signal line are both connected to high-level signals or both connected to low-level signals;
the first control unit comprises a bias adjustment unit electrically connected to the driving unit and configured to implement a bias adjustment on the driving unit;
the pixel circuit also includes a second control unit with a control terminal being electrically connected to a third control line;
the display panel also includes a third shift register with an output terminal being electrically connected to the third control line;
the display panel also includes a third potential signal line electrically connected to the third shift register;
the second potential signal line is electrically connected to the third potential signal line;
the second potential signal line and the third potential signal line are both connected to high-level signals or low-level signals;
the third shift register includes a first sub-shift register and a second sub-shift register, the third potential signal line includes a first sub-potential signal line and a second sub-potential signal line, and in a first direction, the first sub-shift register and the second sub-shift register are respectively located on both sides of the display panel;
the first sub-shift register is electrically connected to the first sub-potential signal line, and the second sub-shift register is electrically connected to the second sub-potential signal line;
in a second direction, the first sub-potential signal line and the second sub-potential signal line are connected on at least one side of the display panel; and
the first direction and the second direction intersect.

10. The display panel according to claim 9, comprising:
a display area; and
a non-display area surrounding the display area,
wherein:
the non-display area includes a first non-display area and a second non-display area located on opposite sides of the display area; and
the second potential signal line and the third potential signal line are electrically connected in the first non-display area and/or the second non-display area.

11. The display panel according to claim 9, wherein:
the first sub-potential signal line, the second sub-potential signal line, and the second potential signal line are electrically connected to a same first signal bus.

12. The display panel according to claim 7, wherein:
the second potential signal line and the third potential signal line are both connected to low-level potentials.

13. The display panel according to claim 12, wherein:
the first shift register is electrically connected to a first high-level signal line;
the second shift register is electrically connected to a second high-level signal line;
the third shift register is electrically connected to a third high-level signal line; and
the first high-level signal line is disconnected from the second high-level signal line and the third high-level signal line.

14. The display panel according to claim 13, wherein:
the second potential signal line is electrically connected to the third potential signal line; and
the second high-level signal line is electrically connected to the third high-level signal line.

15. A display panel-according comprising:
a pixel circuit;
a light-emitting element electrically connected with the pixel circuit;
a first shift register;
a second shift register;
a first potential signal line; and
a second potential signal line,
wherein:
the pixel circuit includes a driving unit, a light-emitting control unit and a first control unit, a control terminal of the light-emitting control unit is connected to a first control line, and a control terminal of the first control unit is connected to a second control line;
an output terminal of the first shift register is electrically connected to the first control line, and an output terminal of the second shift register is electrically connected to the second control line;
the first potential signal line is electrically connected to the first shift register, the second potential signal line is electrically connected to the second shift register, and the first potential signal line and the second potential signal line are isolated from each other;
the first potential signal line and the second potential signal line are both connected to high-level signals or both connected to low-level signals;
the first control unit comprises a bias adjustment unit electrically connected to the driving unit and configured to implement a bias adjustment on the driving unit;
the pixel circuit also includes a second control unit with a control terminal being electrically connected to a third control line;
the display panel also includes a third shift register with an output terminal being electrically connected to the third control line;
the display panel also includes a third potential signal line electrically connected to the third shift register;
the second potential signal line is electrically connected to the third potential signal line;
the second potential signal line and the third potential signal line are both connected to high-level signals or low-level signals;
the pixel circuit also includes a data writing unit configured to write data signals into the driving unit, and the second control unit includes the data writing unit;
the pixel circuit also includes a third control unit and a fourth control unit, a control terminal of the third control unit is connected to a fourth control line, and a control terminal of the fourth control unit is connected to a fifth control line;
the display panel also includes a fourth shift register and a fifth shift register, and output terminals of the fourth shift register and the fifth shift register are electrically connected to the fourth control line and the fifth control line, respectively;
the display panel also includes a fourth potential signal line and a fifth potential signal line, and the fourth potential signal line and the fifth potential signal line are electrically connected to the fourth shift register and the fifth shift register, respectively; and
the first potential signal line is disconnected from the fourth potential signal line and the fifth potential signal line, and the fourth potential signal line, the fifth potential signal line and the first potential signal line are all connected to high-level signals or low-level signals.

16. The display panel according to claim 15, wherein the pixel circuit further comprises:
a threshold compensation unit; and
a gate reset unit,
wherein:
the threshold compensation unit and the gate reset unit are electrically connected to the driving unit;
the third control unit includes the threshold compensation unit; and
the fourth control unit includes the gate reset unit.

17. The display panel according to claim 16, wherein:
at least two of the second potential signal line, the third potential signal line, the fourth potential signal line, and the fifth potential signal line are electrically connected.

18. The display panel according to claim 17, wherein:
the second potential signal line is electrically connected to the third potential signal line;
the fourth potential signal line is electrically connected to the fifth potential signal line; and
the third potential signal line is disconnected from the fourth potential signal line.

19. The display panel according to claim 18, wherein:
the first to fifth potential signal lines are connected to low-level signals.

20. The display panel according to claim 19, further comprising:
first to fifth high-level signal lines electrically connected to the first to fifth shift registers, respectively, wherein:
the first high-level signal line is disconnected from the second to fifth high-level signal lines;
or,
the second high-level signal line is electrically connected to the third high-level signal line;
the fourth high-level signal line is electrically connected to the fifth high-level signal line; and
the third high-level signal line is disconnected from the fourth high-level signal line.
